(19) United States
(12) Patent Application Publication
(10) Pub. No.: US 2018/0209200 A1
(43) Pub. Date: Jul. 26, 2018

(54) DOOR POSITION DETECTION DEVICE FOR ELECTRIC DOOR OPENER

(71) Applicant: FORESEE Garage Doors Co., Ltd, Foshan (CN)

(72) Inventor: Mingshao Jian, Foshan (CN)

(21) Appl. No.: 15/654,726

(22) Filed: Jul. 20, 2017

(30) Foreign Application Priority Data
Jan. 22, 2017 (CN) 201720091493.3

(51) Int. Cl. E05F 15/603; E05F 15/40

(52) U.S. Cl. CPC E05F 15/603; E05Y 2400/32; E05F 15/40

(57) ABSTRACT

The invention relates to a door position detection device for an electric door opener, comprising a housing, in which an input gear in connection with a driving device is mounted and an output gear is further mounted; the input gear and the output gear are linked through a reduction gear unit, a magnet is fixed on the output gear, a magnetic angle sensor circuit board is fixed on the housing above the magnet, and a magnetic angle sensor chip perpendicularly corresponding to the magnet is arranged on the magnetic angle sensor circuit board; the door position detection device is simple and reasonable in structure, has long service life and high precision and can detect any position immediately.

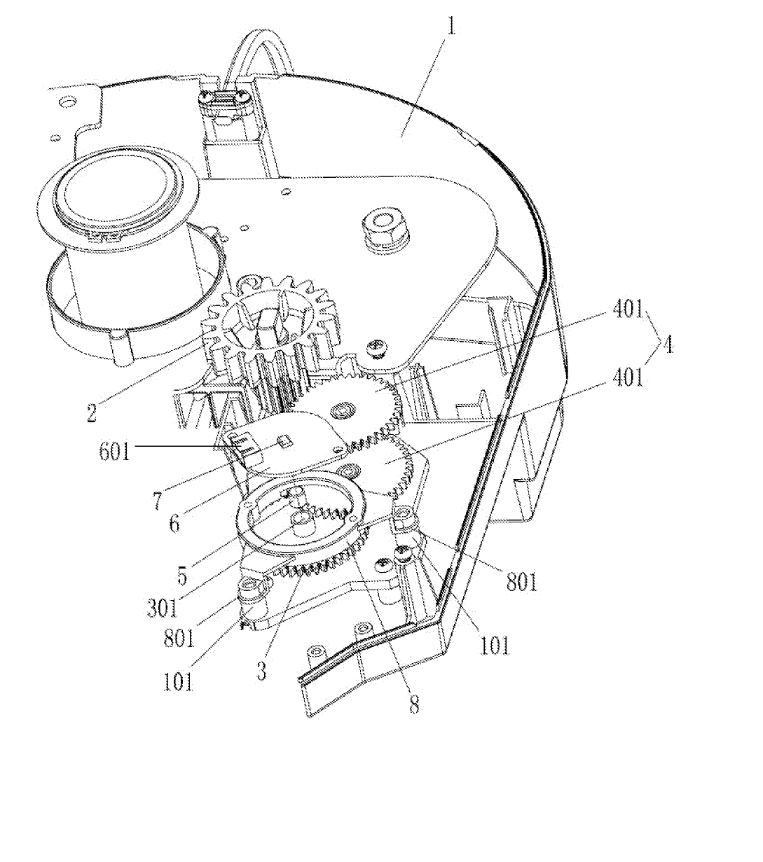

### CROSS-REFERENCE TO RELATED APPLICATIONS

This present application claims the benefit of Chinese Utility Model Application No. 201720091493.3 filed on Jan. 22, 2017, the contents of which are hereby incorporated by reference.

### TECHNICAL FIELD

The invention relates to the technical field of electric door openers, and in particular to a door position detection device for an electric door opener.

### BACKGROUND

At present, door position detection devices for electric door openers have following schemes:

1. Adopting a photoelectric encoder, whose defects lie in that the precision is not high enough and a current position can be calculated only when the door moves for certain distance.

2. Adopting an absolute-value photoelectric encoder, whose defect lies in high cost.

3. Adopting an incremental photoelectric encoder, whose defects lie in that the door position is lost after the door is manually opened when the door opener is powered off, and devices such as limit switch are needed to regain the door position.

4. Adopting a potentiometer, whose defects lie in short service life and low precision.

5. Adopting a limit switch, whose defects lie in that only the fully open or fully closed position of the door can be known, the door cannot be detected at any intermediate position, and more complex functions cannot be realized, for example, slow start and slow stop, or partial opening, positional opening, etc.

### SUMMARY

The invention aims to solve the above defects in existing technologies and provide a door position detection device for an electric door opener, which is simple and reasonable in structure, has long service life and high precision and can detect any position immediately; if a door is pulled randomly after the door opener is powered off, the door position detection device can know the requirement of door position detection immediately once the door opener is powered on; therefore, the problem of door position change of door openers is thoroughly solved, higher-precision door position control is realized and the electric door opener is more diversified and safer in function.

The technical scheme adopted by the invention to solve the technical problem is as follows.

A door position detection device for an electric door opener includes a housing, in which an input gear in connection with a driving device is mounted, characterized in that: an output gear is further mounted in the housing, the input gear and the output gear are linked through a reduction gear unit, a magnet is fixed on the output gear, a magnetic angle sensor circuit board is fixed on the housing above the magnet, and a magnetic angle sensor chip perpendicularly corresponding to the magnet is arranged on the magnetic angle sensor circuit board.

The door position detection device for an electric door opener adopting this structure realizes position detection through the magnet and the magnetic angle sensor chip on the magnetic angle sensor circuit board, that is, the magnet rotates following the output gear, however, the magnetic angle sensor chip above the magnet is immovable, in this way, when the door is at any position within the travel, a unique angle exists between the magnetic field of the radially arranged magnet and the magnetic angle sensor chip, and the detection of the magnetic field angle through the magnetic angle sensor chip may acquire a high-precision (the precision may reach 12 bits, even 14 bits) position signal.

Moreover, even if a door is pulled randomly after the door opener is powered off, the door position detection device can know the requirement of door position detection immediately once the door opener is powered on; therefore, the problem of door position change of door openers is thoroughly solved, higher-precision door position control is realized and the electric door opener is more useful and safer and has longer service life.

The invention may also adopt the following technical means to solve the above problem.

As a preferred scheme, the reduction gear unit includes a first reduction gear and a second reduction gear that are engaged with each other, the first reduction gear is engaged with the input gear, and the second reduction gear is engaged with the output gear; the reduction gear unit may be combined according to different gear ratios.

As a preferred scheme, a fixing bracket is arranged above the magnet, a connection lug is extended on the edge of the fixing bracket, a connection post mated with the connection lug is arranged on the corresponding housing, and the magnetic angle sensor circuit board is fixed on the fixing bracket; the purpose of the fixing bracket is to fix the magnetic angle sensor circuit board, a plurality of connection lugs and a plurality of connection posts are correspondingly mated and are connected through fasteners, with simple and reasonable structure.

As a preferred scheme, the magnetic angle sensor circuit board is provided with an electrical connection port, for the convenience of wiring and signal transmission.

As a preferred scheme, a recessed cavity suitable for accommodating and fixing the magnet is arranged on the output gear, for the convenience of fixing the magnet.

As a preferred scheme, during the working process, the rotation of the output gear is less than 360 degrees, thereby making the computation program simple and being capable of acquiring the unique angle information about the door position in each condition.

As a preferred scheme, the mounting positions of the magnet and the magnetic angle sensor circuit board are exchanged each other; since the magnet and the magnetic angle sensor chip are in relative motion, supposing the magnetic angle sensor circuit board is fixed on the output gear and the magnet is fixed on the fixing bracket, the same purpose also can be achieved.

The invention has benefits as follows.

The door position detection device for an electric door opener in the invention realizes contactless detection, prolongs the service life and realizes immediate detection; if a door is pulled randomly after the door opener is powered off, the door position detection device can know the requirement of door position detection immediately once the door opener is powered on; therefore, the problem of door position change of door openers is thoroughly solved, higher-precision door position control is realized and the electric door opener is more useful and safer.

### BRIEF DESCRIPTION OF THE DRAWINGS

The FIGURE is a structure diagram of the invention.

### DESCRIPTION OF THE EMBODIMENTS

The invention is described below in further detail in conjunction with accompanying drawings and embodiments.

As shown in FIGURE, a door position detection device for an electric door opener includes a housing 1, in which an input gear 2 in connection with a driving device is mounted, characterized in that: an output gear 3 is further mounted in the housing 1, the input gear 2 and the output gear 3 are linked through a reduction gear unit 4, a magnet 5 is fixed on the output gear 3, a magnetic angle sensor circuit board 6 is fixed on the housing 1 above the magnet 5, and a magnetic angle sensor chip 7 perpendicularly corresponding to the magnet 5 is arranged on the magnetic angle sensor circuit board 6.

The door position detection device for an electric door opener adopting this structure realizes position detection through the magnet 5 and the magnetic angle sensor chip 7 on the magnetic angle sensor circuit board 6, that is, the magnet 5 rotates following the output gear 3, however, the magnetic angle sensor chip 7 above the magnet 5 is immovable, in this way, when the door is at any position within the travel, a unique angle exists between the magnetic field of the radially arranged magnet 5 and the magnetic angle sensor chip 7, and the detection of the magnetic field angle through the magnetic angle sensor chip 7 may acquire a high-precision (the precision may reach 12 bits, even 14 bits) position signal.

Moreover, even if a door is pulled randomly after the door opener is powered off, the door position detection device can know the requirement of door position detection immediately once the door opener is powered on; therefore, the problem of door position change of door openers is thoroughly solved, higher-precision door position control is realized and the electric door opener is more useful and safer and has longer service life.

The reduction gear unit 4 includes a first reduction gear 401 and a second reduction gear 402 that are engaged with each other, the first reduction gear 401 is engaged with the input gear 2, and the second reduction gear 402 is engaged with the output gear 3; the reduction gear unit 4 may be combined according to different gear ratios.

A fixing bracket 8 is arranged above the magnet 5, a connection lug 801 is extended on the edge of the fixing bracket 8, a connection post 101 mated with the connection lug 801 is arranged on the corresponding housing 1, and the magnetic angle sensor circuit board 6 is fixed on the fixing bracket 8; the purpose of the fixing bracket 8 is to fix the magnetic angle sensor circuit board 6, a plurality of connection lugs 801 and a plurality of connection posts 101 are correspondingly mated and are connected through fasteners, with simple and reasonable structure.

The magnetic angle sensor circuit board 6 is provided with an electrical connection port 601, for the convenience of wiring and signal transmission.

A recessed cavity 301 suitable for accommodating and fixing the magnet 5 is arranged on the output gear 3, for the convenience of fixing the magnet 5.

During the working process, the rotation of the output gear 3 is less than 360 degrees, thereby making the computation program simple and being capable of acquiring the unique angle information about the door position in each condition.

As a further embodiment, the mounting positions of the magnet 5 and the magnetic angle sensor circuit board 6 are exchanged; since the magnet 5 and the magnetic angle sensor chip 7 are in relative motion, supposing the magnetic angle sensor circuit board 6 is fixed on the output gear and the magnet 5 is fixed on the fixing bracket 8, the same purpose also can be achieved.

The above specific embodiments are merely preferred embodiments of the invention; all equivalent designs made according to the scope of the patent applied by the invention are intended to be covered by the technology of the invention.

1. A door position detection device for an electric door opener, comprising a housing, in which an input gear in connection with a driving device is mounted, characterized in that: an output gear is further mounted in the housing, the input gear and the output gear are linked through a reduction gear unit, a magnet is fixed on the output gear, a magnetic angle sensor circuit board is fixed on the housing above the magnet, and a magnetic angle sensor chip perpendicularly corresponding to the magnet is arranged on the magnetic angle sensor circuit board.

2. The door position detection device for an electric door opener according to claim 1, characterized in that: the reduction gear unit comprises a first reduction gear and a second reduction gear that are engaged with each other, the first reduction gear is engaged with the input gear, and the second reduction gear is engaged with the output gear.

3. The door position detection device for an electric door opener according to claim 1, characterized in that: a fixing bracket is arranged above the magnet, a connection lug is extended on the edge of the fixing bracket, a connection post mated with the connection lug is arranged on the corresponding housing, and the magnetic angle sensor circuit board is fixed on the fixing bracket.

4. The door position detection device for an electric door opener according to claim 1, characterized in that: the magnetic angle sensor circuit board is provided with an electrical connection port.

5. The door position detection device for an electric door opener according to claim 1, characterized in that: a recessed cavity suitable for accommodating and fixing the magnet is arranged on the output gear.

6. The door position detection device for an electric door opener according to claim 1, characterized in that: during the working process, the rotation of the output gear is less than 360 degrees.

7. The door position detection device for an electric door opener according to claim 1, characterized in that: the mounting positions of the magnet and the magnetic angle sensor circuit board are exchanged each other.
